(19) United States
(12) Patent Application Publication
(10) Pub. No.: US 2007/0048116 A1
(43) Pub. Date: Mar. 1, 2007

(54) Lifting/pivoting apparatus for loading board walls and/or loading ramps

(76) Inventor: Thomas Friedrich, Bad Wiessee (DE)

Correspondence Address: DILWORTH & BARRESE, LLP, 333 EARLE OVINGTON BLVD., UNIONDALE, NY, 11553, US

(21) Appl. No.: 11/498,662

(22) Filed: Aug. 3, 2006

(30) Foreign Application Priority Data
Jul. 18, 2005 (DE) UM202005011280.1

(51) Int. Cl. B60P 1/00

(52) U.S. Cl. 414/545

(57) ABSTRACT

The present invention relates to a lifting/pivoting apparatus for loading board walls and/or loading ramps of vehicles and the like comprising at least one lifting arm which can be pivotably hinged to the vehicle around a horizontal lifting arm pivot axis by a lifting arm pivot bearing, on the one hand, and has a loading board wall pivot bearing, on the other hand, for the pivotable fastening of the loading board wall around a horizontal loading board pivot axis, with a pivot drive being associated with the lifting arm pivot bearing and/or with the loading board wall pivot bearing for the pivoting of the lifting arm around the lifting arm pivot axis and/or of the loading board wall to the lifting arm. In accordance with the invention, the lifting/pivoting apparatus is characterized in that the pivot drive is formed by a hydraulic rotary motor which has a motor shaft which is rotatably supported in a housing and is in screw engagement with at least one axially drivable driving piece rotationally fixed with respect to the housing.

### BACKGROUND OF THE INVENTION

The present invention relates to a lifting/pivoting apparatus for loading board walls and/or loading ramps of vehicles and the like comprising at least one lifting arm which can be hinged to the vehicle pivotably around a horizontal lifting arm pivot axis by a lifting arm pivot bearing, on the one hand, and has a loading board wall pivot bearing, on the other hand, for the pivotable fastening of the loading board wall around a horizontal loading board wall pivot axis, with a pivot drive being provided for the pivoting of the lifting arm around the lifting arm pivot axis and/or of the loading board wall or loading ramp to the lifting arm.

Raisable and lowerable loading board walls of trucks can, as a rule, be pivoted out of their approximately perpendicular transport position, in which they are pivoted toward the loading opening of the truck, into a lowered loading position in which they lie on the floor or are held in a predetermined height on the floor approximately parallel thereto. In this process, the loading board walls are, as a rule, supported pivotably such that they can be pivoted out of the vertical transport position into the horizontal loading position. The lifting arms are moreover themselves hinged pivotably to the vehicle chassis in order to effect the lifting movement between the loading edge of the vehicle to the loading edge of the building or to the floor. In this process, the lifting arms can, as a rule, be pivoted upwardly or lowered by a pivot drive. The pivot movement of the loading board wall relative to the lifting arms is achieved, in this process, via a compulsory mechanical control in the form of connector levers and adjustment linkages between the loading board wall and the vehicle chassis which translate a movement of the lifting arms relative to the vehicle chassis into a compulsory movement of the loading board wall relative to the lifting arms. Since the kinematics of the loading board wall is predetermined by its end positions and since moreover a parallel guidance should be achieved at least approximately on lifting movements between the floor and the loading board edge, demands result-for this compulsory mechanical control which are difficult to satisfy and which usually cause complex connector arrangements. The loading board movement in this connection cannot be adapted, or can hardly be adapted, to varying constraints such as vehicle loading in a sloped position. Very large forces moreover arise on the levers and adjustment linkages, with adjustment levers dimensioned sufficiently to limit the adjustment forces on the other hand hindering the placing capability of the loading board wall or loading ramp level with the floor. The multiple member design of the connector arrangements furthermore increases the servicing effort and offers a number of surfaces open to environmental influences such as road salt.

### SUMMARY OF THE INVENTION

The present invention wants to provide a remedy here. It has the underlying object of providing an improved lifting/pivoting apparatus for loading board walls of vehicles which avoids disadvantages of the prior art and further develops the latter in an advantageous manner. The lifting/pivoting apparatus should have a compact construction, permit a more variable movement control and a simple matching of the kinematics of the loading board wall to varying demands and moreover be simple to install.

This object is solved in accordance with the invention by a lifting/pivoting apparatus in accordance with the description herein. Preferred aspects of the invention are also the subject of the description herein.

In accordance with the invention, instead of the conventional pivot drives with hydraulic cylinders for the pivoting of the lifting arms and the compulsory control of the loading board wall by pivot connectors, a hydraulic rotary motor is used for the pivoting of the lifting arms around the lifting arm pivot axis and/or for the pivoting of the loading board wall or loading ramp relative to the lifting arms, said rotary motor having a motor shaft pivotably supported in a housing and in screw engagement with a driving piece which is axially drivable and is arranged rotationally fixedly in the housing. With reverse kinematics, the driving piece could alternatively or additionally also be in screw engagement with the housing, with the aforesaid design with screw engagement, however, only being preferred at the motor shaft for technical production reasons. If the driving piece is axially displaced by hydraulic pressure, the thread engagement translates the axial movement of the driving piece into a rotary movement of the motor shaft. In this connection, the housing and the motor shaft are coupled to the parts pivoting with respect to one another and are preferably directly connected thereto. The elimination of the hydraulic cylinders customary in the prior art for the pivoting of the lifting arms and of the connection positions required for this as well as of the pivot connectors for the translation of the lifting arm pivot movements into additional loading board wall movements around the loading board pivot axle saves a number of bearing and lubrication positions and considerably simplifies maintenance. In addition, there is less of a jungle in the loading area of the vehicle which makes access to the vehicle chassis more difficult. The solution in accordance with the invention furthermore offers fewer positions open to road salt, grit or the like.

The presently proposed lifting/pivoting apparatus advantageously dispenses with a compulsory mechanical coupling of the loading board movement to the lifting arm position. In this connection, a second rotary motor can be provided for the pivoting of the loading board wall relative to the at least one lifting arm, said second rotary motor advantageously being able to be controlled separately and independently of the first rotary motor for the pivoting of the at least one lifting arm. This makes it possible to bring the loading board wall into different positions for a predetermined lifting arm position without lift arm movement. A pivot movement of the loading board wall relative to the at least one lifting arm can naturally be predetermined in dependence on its movement for the achievement of a harmonious loading board wall movement by the control. It is, however, possible to change this dependency in a simple manner by the separate second rotary motor and to preset e.g. a plurality of movement sequences of the loading board wall in dependence on the lifting arm movement. A considerable time gain can also hereby be achieved in the loading board wall actuation since unnecessary intermediate positions can be saved depending on the movement. For example, on the lowering of the loading board wall from the folded transport position into the loading position on the floor without goods, the load shifting position, which has to be moved to in a compulsory fashion in the prior art and in which the lifting arms are pivoted upwardly and the loading board wall projects approximately horizontally from the loading base edge, can thus be omitted, with the lifting arms simultaneously being rocked down and the loading board wall being lowered. Due to the omission of the compulsory mechanical coupling of the two pivot movements of the lifting arms and the loading board wall and the independent selectability of the two movement axes, the named intermediate position for the load shifting from the loading board wall into the vehicle and vice versa only has to be moved to if it is desired. A control apparatus can advantageously be provided which controls the two rotary motors and thus the two pivot motors in accordance with different desired, advantageously pre-programmable cinematic sequences. The control apparatus can effect different dependencies between the pivot movement of the lifting arms and the pivot movement of the loading board wall relative to the lifting arms.

To achieve a particularly compact arrangement, the driving piece in screw engagement with the motor shaft and/or the housing itself forms a hydraulically actuable piston which is axially displaceably supported in the housing and is in engagement with the thread of the motor shaft. It would generally also be possible to drive the axial driving piece by a separate piston, in particular a plunger piston, which can have advantages with respect to a limiting of the forces arising. The aforesaid embodiment in which the driving piece itself forms the piston is, however, of advantage with respect to the construction size and moreover reduces the number of components.

In a further development of the invention, each rotary motor can have at least two driving pieces which are made counter-revolving and of which one is in engagement with the motor shaft via a left hand thread and the other is in engagement with the motor shaft via a right hand thread. Axial forces on the motor shaft can be avoided by such driving pieces arranged in pairs and counter-revolving and higher torques can moreover be achieved. Optionally, a plurality of such counter-revolving driving pieces can also be seated on a motor shaft to be able to achieve high torques with limited hydraulic pressure.

In accordance with an advantageous embodiment of the invention, the second rotary motor for the pivoting of the loading board relative to the at least one lifting arm is seated at the projecting end of the lifting arm, with the second rotary motor simultaneously being able to form the loading board wall pivot bearing. In this embodiment, the second rotary motor is therefore seated spaced apart from the first rotary motor for the pivoting of the lifting arms at the oppositely disposed end of the at least one lifting arm directly at the hinge point of the loading board wall. The torque for the loading board movement is thereby generated directly where it is needed. Additional axial forces on the lifting arm and on its bearing, such as occur with conventional connector and linkage solutions, can be avoided.

An oil feed to the second rotary motor at the projecting end of the at least one lifting arm advantageously takes place in a tubeless manner. In a further development of the invention, a hydraulic passage can be provided in the at least one lifting arm for the supply of the second rotary motor. In this connection, a central oil feed can advantageously be provided at the motor shaft of the first rotary motor from which the first rotary motor is fed, on the one hand, through a pressure passage in the said motor shaft of the first rotary motor, whereas the second rotary motor is fed via the lifting arm via a branching into the at least one lifting arm.

Alternatively to the arrangement of the second rotary motor at the projecting end of the at least one lifting arm, the second rotary motor can be combined with the first rotary motor to form one motor unit or, like the first rotary motor, can be arranged in the region of the lifting arm pivot bearing at the vehicle chassis and can in particular form the lifting arm pivot bearing. A transfer of the movement of the second rotary motor to the loading board wall can take place via a connector linkage which is connected to the motor shaft of the second rotary motor on the one hand and is connected to the loading board wall on the other hand.

The two rotary motors are advantageously integrated into a common motor housing, but the energy charging of the second rotary motor takes place independently of that of the first rotary motor, in particular via separate pressure chambers.

The two motor shafts of the two rotary motors can advantageously be arranged coaxially to one another. The motor shaft of the one rotary motor can in particular be received in the hollow motor shaft of the other rotary motor.

In an advantageous further development of the invention, at least the second rotary motor for the pivoting of the loading board wall relative to the at least one lifting arm has a pivot range of over 100°, preferably of over 180° so that the loading board wall cannot only be pivoted from the substantially vertical transport position into the substantially horizontal loading position, that is over a pivot range of approximately 90°. The large pivot range of the second rotary motor in particular also permits the loading board wall to be brought into further operating positions. The loading board wall can in particular optionally be folded toward the at least one lifting arm and/or be pivoted beneath the floor of the vehicle chassis. This is in particular of advantage when the loading board wall is foldable so that a loading board wall part can be folded together relative to the other loading board wall part, preferably around a folding axis parallel to the loading board pivot axis.

To achieve an arrangement of the lifting/pivoting apparatus which is particularly shallow in construction, the housing of the first and/or second rotary motor can have a cross-section differing from the circular, in particular a pressed-flat, oval cross-section. Apart from the shallow, compact construction, with this construction form the security of the driving piece or of the piston with respect to the housing is, so-to-say, included. Alternatively or additionally, the driving piece can also be secured against rotation via a separate security against rotation in the form of a longitudinal groove, in particular in the form of a spline shaft/hub profile.

Advantageously, a surface pair on piston and shaft and/or on piston and housing effecting the screw engagement can simultaneously form a sealing surface pair for the sealing of the pressure chamber for the charging of the piston with pressure. The same piston section simultaneously serves the transfer of torque and sealing. A considerably reduced construction length can hereby be achieved since the axial spacing between the sealing section and the rotary guide section or the screw engagement section of the piston is dispensed with. In addition, the respective components, in particular the housing and the shaft, can be manufactured in an endless manner and be produced as needed and in the required length.

The piston advantageously has effective piston surfaces of equal sizes at both oppositely disposed sides. The complete piston surface can effectively be used with equal forces in both directions. The total inner diameter surface of the housing is practically available as the piston pressing surface, only reduced by the shaft cross-section. The same torques can hereby be generated in both drive directions with the same hydraulic pressures. In addition, a maximum torque yield results for a given pressure.

In a further development of the invention, the screw engagement between the shaft and the piston can also be achieved differently than by a conventional threaded mesh section of the shaft and of the piston. The shaft can be twisted in itself so that its outer contour forms a spirally twisted polygonal section rotated around the longitudinal axis of the shaft. This not only simplifies the production, but also improves the sealing capability between the shaft and the piston. The inner jacket surface in screw engagement with the twisted polygonal section can be made free of thread meshing and have a continuous, constant surface extent without impressions or projections so that the piston and the twisted polygonal section of the shaft are seated on one another in the manner of a plain bearing surface pair.

The spirally twisted polygonal section of the shaft can advantageously have a cross-section pressed flat, e.g. be rectangular or oval. To achieve a favorable torque yield, the cross-section can advantageously have a longitudinal axis which is at least 30% and preferably more than 50% longer than the transverse axis of the cross-section. A square cross-section or a hexagonal section would admittedly also be usable in which the ratio of longitudinal axis to transverse axis of the cross-section substantially amounts to 1:1. However, less favorable lever ratios result for the torque yield there than with a cross-section pressed flat. The cross-section is advantageously also free of sharp kinks or edges to improve the sealing capability.

### BRIEF DESCRIPTION OF THE DRAWINGS

The invention will be explained in more detail in the following with reference to preferred embodiments and to associated drawings. There are shown in the drawings:

FIG. 1: a schematic side view of a lifting/pivoting apparatus for a loading board wall comprising two separate rotary motors in accordance with an advantageous embodiment of the invention, with different positions of the loading board wall being shown in the representations (a) to (d);

FIG. 2: a schematic side view of the lifting/pivoting apparatus similar to FIG. 1, with the loading board wall being able to be folded together on itself in this embodiment and being able to be pivoted under the floor of the vehicle body by the lifting/pivoting apparatus, with the representations (a) to (e) showing different positions of the loading board wall;

FIG. 3: a schematic side view of the lifting/pivoting apparatus similar to FIG. 1, with the loading board wall being able to be folded together on itself in this embodiment and being able to be folded to the lifting pivot arms of the vehicle chassis by the lifting/pivoting apparatus, with the representations (a) to (e) showing different positions of the loading board wall;

FIG. 4: a longitudinal section through the lifting arms of the lifting/pivoting apparatus from the preceding Figures, which shows the two separate rotary motors at the two hinge points;

FIG. 5: a plan view of the oil feed into the motor shaft of the first rotary motor;

FIG. 6: a longitudinal section through a variant of the rotary motor for the lifting pivot arms whose oil feed takes place via the motor housing;

FIG. 7: a longitudinal section through a rotary motor of the lifting/pivoting apparatus from the preceding Figures, with an oil feed via the pivot arms being shown and the rotary motor being shown in a different position in comparison with FIG. 6;

FIG. 8: a longitudinal section through a rotary motor of the lifting/pivoting apparatus from the preceding Figures in accordance with an alternative embodiment according to which two piston pairs are seated on the motor shaft;

FIG. 9: a longitudinal section through the rotary motor of FIG. 8 in another rotary position;

FIG. 10: a schematic side view of a lifting/pivoting apparatus in accordance with a further embodiment of the invention in which the two rotary motors are arranged coaxially to one another and both are integrated into the lifting arm pivot axle, with the transmission of the rotary movement to the loading board wall taking place via a connector, with the representations (a) to (d) showing different positions of the board wall;

FIG. 11: a longitudinal section through the two rotary motors from FIG. 10 combined to form one motor unit;

FIG. 12: a longitudinal section through the motor unit of FIG. 11 in another rotary position,

FIG. 13: a cross-section through a rotary motor in accordance with an embodiment in accordance with one of the preceding Figures with an oval cross-section; and

FIG. 14: a longitudinal section through the rotary motor of FIG. 13.

### DESCRIPTION OF THE PREFERRED EMBODIMENTS

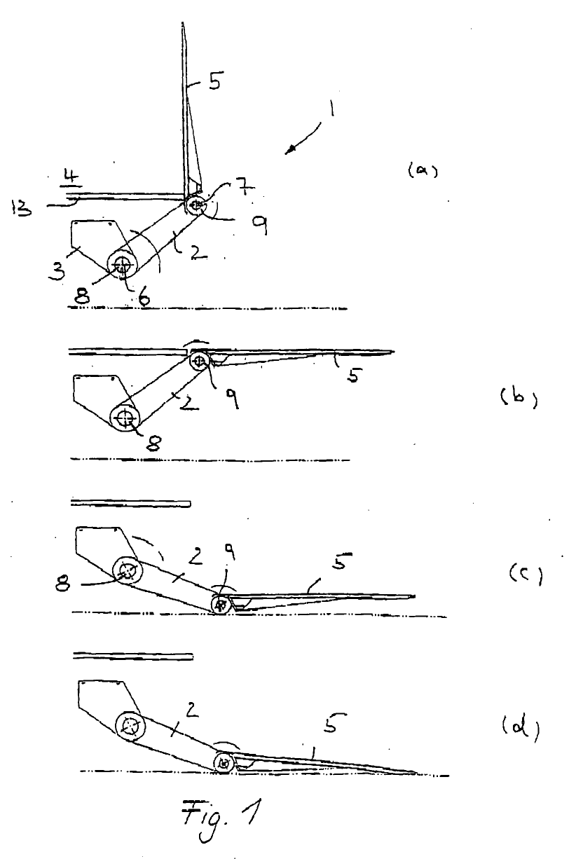

The lifting/pivoting apparatus 1 shown in FIG. 1 comprises a pair of lifting arms 2 arranged at the right and at the left beneath the vehicle rear and connected on the one hand to the chassis 3 of the vehicle 4 and on the other hand to the loading board wall 5. The lifting arms 2 are pivotably supported on the vehicle chassis 3 around a horizontal lifting arm pivot axis 6 which extends transversely to the longitudinal direction of the lifting arms 2 and is aligned transversely to the direction of travel of the vehicle 4 in the embodiment shown in which the loading board wall 5 is disposed at the rear of the vehicle.

Furthermore, the loading board wall 5 is pivotable relative to the lifting arms 2 around a loading board pivot axis 7 which extends parallel to the lifting arm pivot axis 6.

The lifting arm pivot axis 6 and the loading board wall pivot axis 7 have two separate rotary motors 8 and 9 respectively associated with them which are advantageously integrated into the lifting arm pivot bearing 10 defining the lifting arm pivot axis 6 or into the loading board wall pivot bearing 11 defining the loading board wall pivot axis 7 and advantageously form these two pivot bearings 10 and 11.

The two rotary motors 8 and 9 can be selected independently of one another so that generally the loading board wall can be pivoted independently of the position or the movement of the lifting arms 2. A control can naturally be provided which presets a loading board pivot movement in dependence on the position or movement of the lifting arms 2, in particular to pivot the loading board wall 5 with respect to the lifting arms 2 on a lowering of the lifting arms 2 such that a horizontal guidance of the loading board wall 5 is possible independently of the optionally inclined vehicle position. The representations (b), (c) and (d) of FIG. 1 show this.

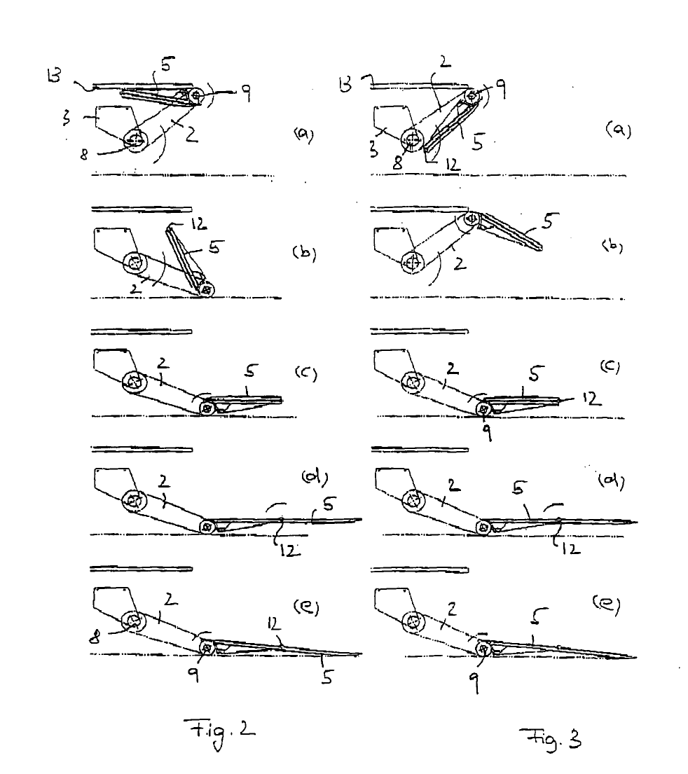

The movability of the board wall relative to the lifting arms programmable as desired becomes even clearer from the representations of FIGS. 2 and 3 in which the loading board wall 5 can be folded together, i.e. has two halves 5a and 5b (cf. FIGS. 2 and 3) which can be folded together around a folding axis 12 which extends parallel to the loading board wall pivot axis 7. As the representation of FIG. 2 shows, the second rotary motor 9 can in particular be used to pivot the folded together loading board wall 5 prior to the raising of the lifting arms 2 so far toward the lifting arms 2 that the folded together loading board wall 5 moves beneath the vehicle floor 13 on the upward pivoting of the lifting arms 2. Alternatively, the folded together loading board wall 5 can be folded downwardly toward the lifting arms 2 by the second rotary motor 9 at the loading board wall pivot axis 7 after the raising of the lifting arms 2 and in the opposite sense to the pivot movement of the lifting arms 2, as representation (a) in FIG. 3 shows. If representations 2 (a) and 3 (a) are compared, it can be recognized that the loading board wall 5 can be pivoted by the second rotary motor 9 over a range of more than 270° with respect to the lifting arms 2. This is difficult to achieve with a conventional connector and pivot lever coupling.

In addition, the disadvantage—which cannot be overcome in conventional lifting/pivoting drives—is avoided that a gap remains between the loading board wall and the vehicle floor in the raised position of the lifting arms 2 with a still horizontal loading board wall 5. This gap or a rounded section of the loading board wall edge causing the gap is necessary in the prior art with a compulsory control of the pivot movement of the loading board wall in dependence on the lifting arm position to avoid a collision with the loading board edge on a further upward pivoting of the loading board wall and also to provide the tolerances required for the deflection of the cylinder bearings. The independent control facility of the two rotary motors, however, permits the lifting arms to be rocked down a little and so to move the loading board wall away from the loading board edge before the loading board wall is pivoted fully upwardly and the lifting arms are then rocked up completely. The same naturally applies vice versa on the moving to the said intermediate position for the load shifting from the loading floor to the loading board wall from above out of the transport position and/or from below from the floor position. As FIG. 1 (b) shows, the lifting arms 2 can be brought into their fully raised position when the loading board wall is horizontal so that a gap between the loading floor edge and the loading board wall is almost completely avoided.

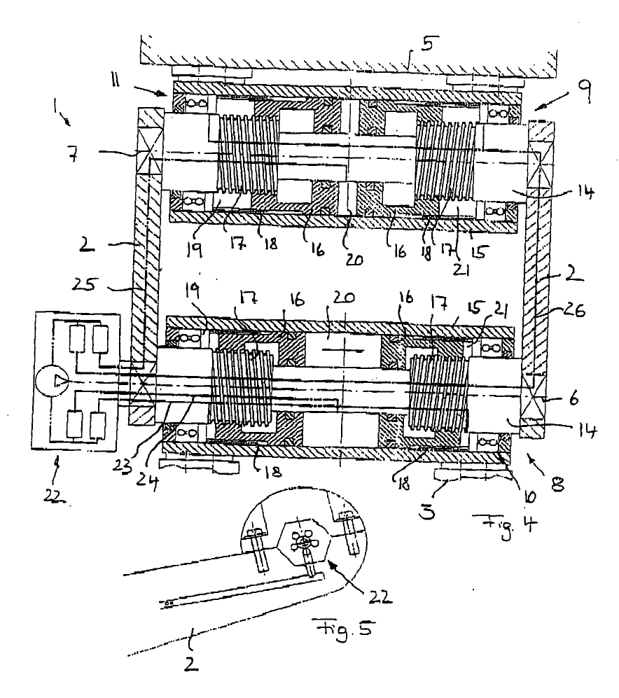

The two rotary motors 8 and 9 are, as FIG. 4 shows, advantageously each hydraulic rotary motors with a motor shaft 14 which is received in a cylindrical, shell-shaped housing 15 and exits it on both end sides of the said housing 15. Two driving pieces 16, which are made as pistons and are each in engagement with a respective thread section 17 of the motor shaft 14, are seated on the motor shaft 14. The thread sections 17 of the motor shaft 14 are made in opposite senses as left hand and right hand threads so that the two driving pieces 16 work in opposite senses.

The driving pieces 16 forming pistons are axially displaceably, but rotationally fixedly guided in the housing 15, for example via spline shaft/hub profile sections 18. The driving pieces 16 forming pistons are sealed with respect to the housing 15 such that pressure chambers 19, 20 and 21 are formed on both sides of each piston, with a common pressure chamber 20 being provided between the two pistons.

By pressure charging of the pressure chambers 20 provided between the two driving pieces 16, the latter are pressed apart, whereas a pressure charging of the outwardly disposed pressure chambers 19 and 21 results in a pressing together of the driving pieces 16. The axial movement of the driving pieces 16 is translated via the thread sections 17 into a corresponding rotary movement of the motor shaft 14. Axial forces on the motor shaft 14 can be avoided by the counter-revolving arrangement of the two driving pieces 16.

As FIG. 4 shows, the housing 15 of the first rotary motor 8 is fastened rotationally fixedly directly to the vehicle chassis 3. The loading board wall 5 is, in contrast, fastened rotationally fixedly to the housing 15 of the second rotary motor 9. Provision can also be made in an advantageous manner that the bearing covers, which close the housing at the end face and can be rotationally fixedly connected to the tubular housing 15, in particular screwed or welded, effect the rotationally fixed connection via an adjustment lever. At the same time, the motor shafts can be supported at the bearing covers such that a direct introduction of force from the motor shaft 14 and thus low bending torques on the housing 15 can be achieved.

A particular advantage of the hydraulic rotary motors is their compact, in particular shallow construction. As becomes particularly clear from FIG. 1(d), the connection point of the loading board wall at the lifting arm side can be brought particularly low over the floor by the small cross-section of the second rotary motor 9 and the loading board wall can thus be placed onto the floor with a minimum angle of inclination. This is practically impossible with conventional lifting mechanisms since the pivot connectors to be connected to the loading board wall have to have a sufficient lever there with respect to the loading board wall pivot axis, which unavoidably causes a greater height of the loading board wall point above the floor on the lifting arm side.

The stubs of the motor shaft 14 exiting the housing 15 carry the two lifting arms 2 which are naturally rotationally fixedly fastened to the motor shaft 14. The other ends of the lifting arms 2 are connected to the stubs of the motor shaft 14 of the second rotary motor 9 likewise exiting the housing 15.

The pressure fluid feed of the two rotary motors 8 and 9 takes place in each case via the motor shafts 14. A central pressure fluid supply 22 is seated at the axial end of the motor shaft 14 of the first rotary motor 8. The pressure chambers 18 and 21 or alternatively 20 of the first rotary motor 8 can be charged with hydraulic oil via pressure fluid passages 23 and 24 in the motor shaft 14 of said first rotary motor 8 to move the pistons to and fro in the desire manner.

Furthermore, pressure fluid passages 25 and 26 branch off from the central pressure fluid supply 22 into the motor shaft 14 of the first rotary motor 8 into the lifting arms 2 which are fastened thereto and through which the said pressure passages 25 and 26 are continued. They lead via the said lifting arms 2 into the motor shaft 14 of the second rotary motor 9 to open there into its pressure chambers 18 and 21 or 20 (cf. FIG. 4). This pressure fluid supply of the second rotary motor 9 via the lifting arms 2 avoids hydraulic tubes and permits the installation of the lifting/pivoting apparatus with only one pressure supply connection.

The central pressure fluid supply 22 can be in direct fluid communication with the motor shaft 14 of the first rotary motor 8. It can optionally also be connected by means of a hydraulic rotary leadthrough.

FIG. 5 shows the screw connection of the motor shaft 14 of the first rotary motor 8 to the lifting arm 2 with a simultaneously sealing connection of the pressure oil supply. The passages can optionally also serve for control purposes or for the adjustment of the folding loading board wall.

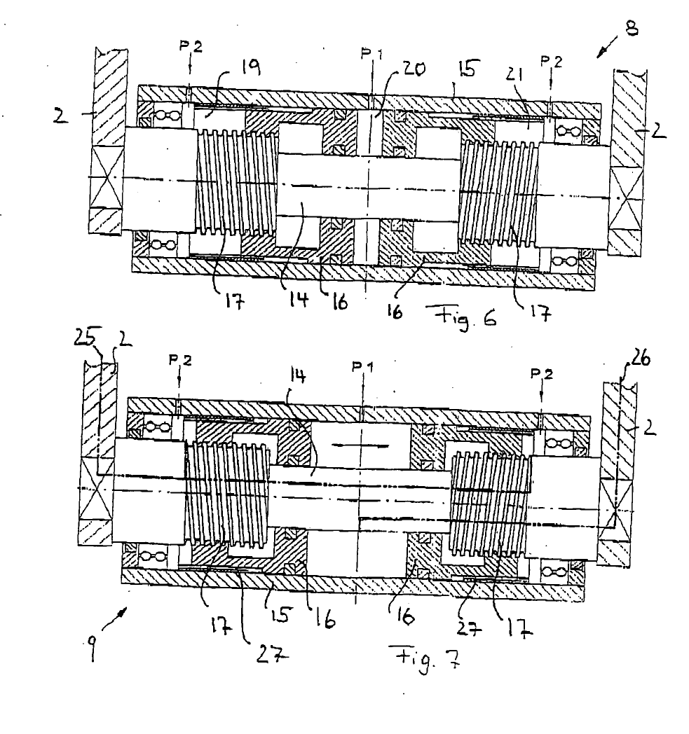

FIG. 6 shows an alternative embodiment of the rotary motor 8 or of the rotary motor 9 in which the pressure feed into the pressure chambers 19, 20 and 21 takes place via the housing 15.

FIG. 7 shows both options, namely that the pressure feed into the pressure chambers 19, 20 and 21 can take place both via the housing 15 and via the motor shaft 14 and the lifting arms 2 connected thereto.

Alternatively to the previously described rotationally fixed guidance of the driving pieces 16 forming the pistons at the housing 15 by spline shaft/hub profiles, the outer piston guides at the housing 15 can advantageously also likewise be made as thread mesh, in particular as steep tread mesh 27, for the achieving of larger angles of rotation or torques, as FIG. 7 shows. The thread engagement between the driving pieces 16 and the housing 15 can be provided additionally or alternatively to the thread engagement with the motor shaft 14. The latter can optionally be replaced by a rotationally fixed axial guidance, for example by a spline shaft/hub connection, so that the driving pieces are guided only axially displaceably, but rotationally fixedly, on the motor shaft 14. Advantageously, however, the thread engagement at the outer piston guide can be provided additionally to the thread engagement on the motor shaft 14 to achieve larger angles of rotation or torques. Ball-like or roller-like easy running guides can also selectively be provided to reduce the friction.

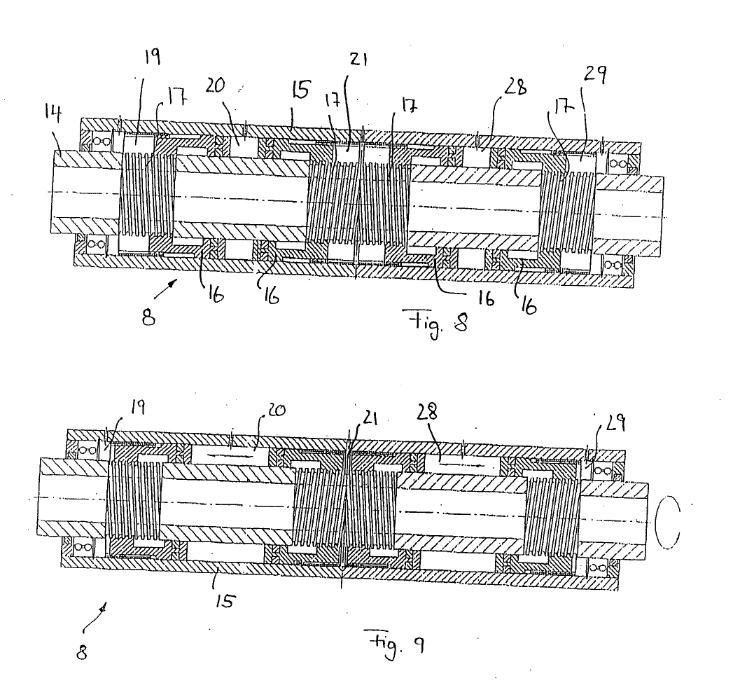

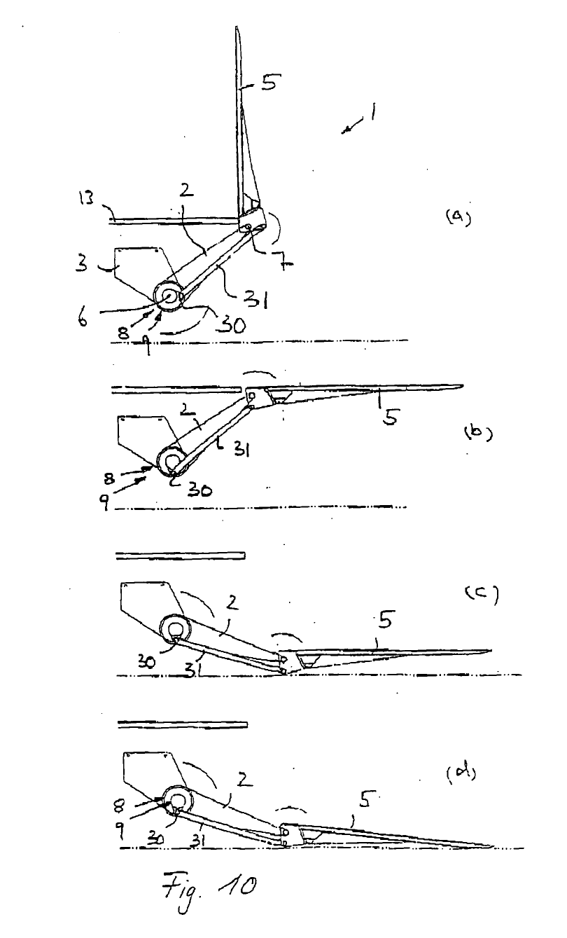

To nevertheless be able to achieve the desired torque with a reduced diameter of the rotary motors 8 and 9, the rotary motors 8 and 9 can also be made as a twin piston motor as FIGS. 8 and 9 show. In this connection, differently than with the previously described embodiments, not only one pair of driving pieces 16 is seated on the motor shaft 14, but rather two pairs of in each case counter-revolving driving pieces 16 which are each in screw engagement with counter-revolving thread sections 17 of the motor shaft 14. If the pressure chambers 19, 21 and 29 are charged with the pressure P1, the counter-revolving piston pairs move together, as FIG. 8 shows. If, in contrast, the pressure chambers 20 and 28 are charged with the pressure P2, the driving pieces 16 made as pistons move apart, as FIG. 9 shows, so that the respective rotary movements of the motor shaft 14 are adopted.

In the embodiment shown in FIGS. 8 and 9, the pressure chambers 19, 20, 21, 28 and 29 are fed via the housing 15. It is, however, understood that a pressure fluid feed can also be provided via the motor shaft 14 here, as was previously described.

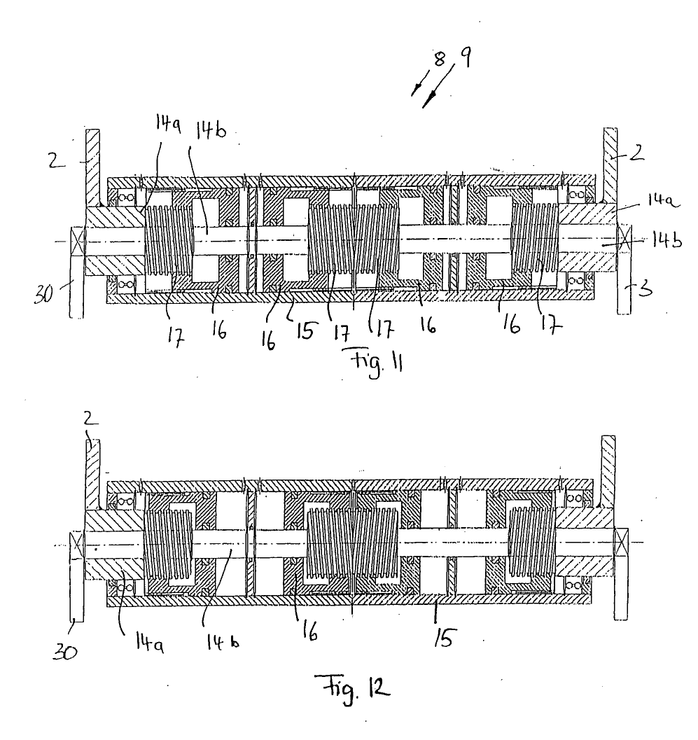

An alternative embodiment of the lifting/pivoting apparatus 1 is shown in FIG. 10. With respect to the arrangement of the lifting arms 2 and of the pivotable support of the loading board wall 5 at the lifting arms 2, this embodiment generally corresponds to the previously described one in accordance with FIGS. 1 to 3, but the second rotary motor 9 for the pivot movement of the loading board wall 5 relative to the lifting arms 2 is not seated at the joint position between the lifting arms 2 and the loading board wall 5. The second rotary motor 9 is rather combined with the first rotary motor 8 to form a common motor unit, as FIGS. 11 and 12 show. This combined motor unit comprises two motor shafts 14 (a) and 14 (b) which are arranged coaxially to one another and of which one is rotationally fixedly connected to the lifting arms 2 and the other drives a crank 30 which is coupled via a connector 31 to the loading board wall 5 to pivot it with respect to the lifting arms 2 (cf. FIG. 10).

As FIGS. 11 and 12 show, the motor shaft 14 (a) of the first rotary motor 8, which is rotationally fixedly connected to the lifting arms 2, is made as a hollow shaft so that the motor shaft 14 (b) of the second rotary motor 9 can extend through the motor shaft 14 (a) of the first rotary motor 8. It projects axially from the end faces of the motor shaft 14 (a) is rotationally fixedly connected there to the crank 30 and via the latter to the connector 31. The second rotary motor 9 is arranged, so-to-say, in the first rotary motor 8. The two rotary motors 8 and 9 have a common housing 15 in which the pistons formed by the respective driving pieces 16 are guided in the previously described manner and are received in a fluid-tight manner to form the corresponding pressure chambers.

The two cranks 30 to the right and left on the motor shaft 14 (b) are synchronized by the latter. This is no longer the case in the two lifting arms 2 since the motor shaft 14 (a) of the first rotary motor 8 is no longer made in a throughgoing manner. The synchronization of the lifting arms 2 or of the split motor shaft 14 can, however, be established via a torsion tube.

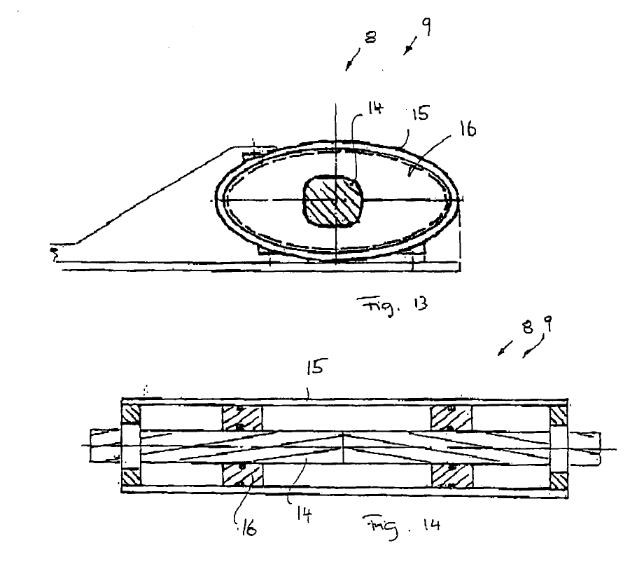

To achieve a particularly low construction height so that the lifting/pivoting apparatus 1 can be arranged particularly compactly under the vehicle floor, the embodiment of FIG. 13 provides that the rotary motor 8 does not have a circular cross-section, but a pressed flat, in particular oval, cross-section or one adapted to the installation relationships. Both the housing 15 and the pistons guided therein, which are formed by the driving pieces 16, are oval in cross-section. The compact construction which can thereby be achieved is very important to realize shallow run-off angles of a loading board wall set on the floor. In addition, the torque on the pistons can simultaneously be actively taken up via the oval shape so that optionally a rotationally fixed longitudinal guidance, for example in the form of a spline shaft/hub connection, can be omitted.

Furthermore, FIGS. 13 and 14 show that the motor shaft 14 can be made as a twisted polygonal shaft or multiple spline shaft, whereby an economic production can be achieved. The driving pieces 16 forming the pistons can be sealed directly on the shaft profile (cf. FIG. 14).

1. A lifting/pivoting apparatus for loading board walls (5) and/or loading ramps of vehicles and the like comprising
at least one lifting arm (2) which is pivotably connectable to the vehicle (4) by a lifting arm pivot bearing (10) around a horizontal lifting arm pivot axis (6) on the one hand and,
on the other hand, has a loading board wall pivot bearing (11) for the pivotable fastening of the loading board wall (5) around a horizontal loading board wall pivot axis (7),
with a pivot drive (8, 9) for the pivoting of the lifting arm (2) around the lifting arm pivot axis (6) and/or of the loading board wall (5) to the lifting arm (2) being associated with the lifting arm pivot bearing (10) and/or the loading board wall pivot bearing (11),
wherein the pivot drive (8, 9) being formed by a hydraulic rotary motor which has a motor shaft (14) which is rotatably supported in a housing (15) and is in screw engagement with at least one axially drivable driving piece (16) rotationally fixed with respect to the housing (15).

2. A lifting/pivoting apparatus in accordance with claim 1, wherein a first rotary motor (8) is provided for the pivoting of the lifting arm (2) around the lifting arm pivot axis (6) and a second rotary motor (9) is provided for the pivoting of the loading board wall (5) or loading ramp relative to the at least one lifting arm (2) around the loading board wall pivot axis (7).

3. A lifting/pivoting apparatus in accordance with claim 1, wherein the driving piece (16) in screw engagement with the motor shaft (14) is axially displaceable by a hydraulically chargeable piston and in particular itself forms a piston.

4. A lifting/pivoting apparatus in accordance with claim 2, wherein the second rotary motor (9) is arranged at the projecting end of the at least one lifting arm (2) and/or forms the loading board wall pivot bearing (11).

5. A lifting/pivoting apparatus in accordance with claim 1, wherein at least one hydraulic passage (25, 26) for the supply of the second rotary motor (9) with hydraulic oil is provided in the at least one lifting arm (2).

6. A lifting/pivoting apparatus in accordance with claim 2, wherein the second rotary motor (9) is combined with the first rotary motor (8) to form a motor unit and/or is arranged at the lifting arm pivot bearing (10) and can be coupled to the loading board wall (5) via a pivot connector (31).

7. A lifting/pivoting apparatus in accordance with claim 1, wherein the motor shaft (14b) of the one rotary motor (9) is received in the hollow motor shaft (14a) of the other rotary motor (8) and the two rotary motors (8, 9) have a common housing (15) in which the driving pieces (16) of the two rotary motors are guided.

8. A lifting/pivoting apparatus in accordance with claim 1, wherein a central oil feed (22) is provided at the motor shaft (14) of the rotary motor (8), a pressure passage (23, 24) is provided in the motor shaft (14) for the feed of the pressure chambers (19, 20, 21) of the rotary motor (8) and a branching in the motor shaft (14) leads into a pressure passage (25, 26) in the lifting arm (2) connected to it.

9. A lifting/pivoting apparatus in accordance with claim 1, wherein the housing (15) and/or the piston of the first and/or second rotary motors (8, 9) has/have a cross-section deviating from the circular, preferably a flat-pressed cross-section, in particular an approximately elliptical or oval cross-section.

10. A lifting/pivoting apparatus in accordance with claim 1, wherein a surface pair on motor shaft (14) and driving piece (16) effecting the screw engagement simultaneously forms a sealing surface pair for the sealing of the driving piece (16) with respect to the motor shaft 14) as well as with respect to a pressure medium chamber charging the driving piece (16).

11. A lifting/pivoting apparatus in accordance with claim 1, wherein the motor shaft (14) has at least one screw engagement section which is made as a polygonal section twisted spirally in the longitudinal axis of the motor shaft.

12. A lifting/pivoting apparatus in accordance with claim 1, wherein the driving piece (16) has equally large effective pressure charging surfaces at both sides which in particular correspond approximately to an inner cross-sectional surface of the housing less a motor shaft cross-sectional surface.

13. A lifting/pivoting apparatus in accordance with claim 1, wherein the housing (15) of the first and/or second rotary motors (8, 9) forms a closed cylindrical shell from which substantially only the ends of the motor shaft (14) project.

14. A lifting/pivoting apparatus in accordance with claim 1, wherein the first and/or second rotary motors (8, 9) has at least two counter-revolving driving pieces (16) of which one is in screw engagement with the motor shaft (14) with left hand thread and another with right hand thread.

15. A lifting/pivoting apparatus in accordance with claim 1, wherein the loading board wall (5) has two loading board wall parts which are connected to one another foldably around a folding axis (12) parallel to the loading board wall pivot axis (7) and can be folded into a transport position folded to the at least one lifting arm (2).

16. A lifting/pivoting apparatus in accordance with claim 1, wherein at least the second rotary motor (9) has a pivot range of over 100°, preferably of over 180°.

17. A lifting/pivoting apparatus in accordance with claim 1, wherein it is made free from a compulsory mechanical coupling which translates a lifting arm movement in a compulsory manner into a loading board wall movement relative to the lifting arm (2).

18. A lifting/pivoting apparatus in accordance with with claim 2, wherein the first and the second rotary motor (8, 9) can be controlled by a control apparatus such that different loading board wall positions can be moved to for a predetermined lifting arm position and/or different lifting arm positions can be moved to for a loading board wall position predetermined relative to the lifting arm.

19. A lifting/pivoting apparatus in accordance with claim 1, wherein the control apparatus is made such that, for a movement of the loading board wall between two presettable positions, in particular between the upwardly folded transport position and the lowered floor position, different cinematic sequences can be selected and/or the sequence of the lifting arm pivot movement is variable in dependence on the loading board wall pivot movement and vice versa.

20. A lifting/pivoting apparatus in accordance with claim 1, wherein the control apparatus has a selection device by which a choice can be made between a load-free lifting/lowering routine in which the loading board wall can be moved to and fro between the lowered floor position and the upwardly folded transport position without moving to the load shifting position in which the loading board wall is adjacent to the loading floor edge while projecting approximately horizontally from the loading floor edge and a load-raising lifting/lowering routine in which the loading board wall moves to the said load shifting position on the raising from the lowered floor position and/or on the lowering from the raised transport position.

21. A lifting/pivoting apparatus in accordance with claim 1, wherein the control apparatus is made such that, for the moving to and/or leaving of the load shifting position in which the loading board wall is adjacent to the loading floor edge while projecting approximately horizontally from the loading floor edge, the loading board wall with the second rotary motor (9) is first brought into the desired alignment with the lifting arm (2) and then the lifting arm is pivoted by the first rotary motor (8) without pivoting of the loading board wall to move the loading board wall to the loading floor edge.
